(19) United States
(12) Patent Application Publication
(10) Pub. No.: US 2009/0210103 A1
(43) Pub. Date: Aug. 20, 2009

(54) Controlling aircraft aerial movements, defeating icing on aircraft surfaces, aiding decontamination, and damping turbulence effects on aircraft by the method of micro-perforated airfoil coordinated precision flow management

(75) Inventor: Michael Leon Cook, Kent, WA (US)

Correspondence Address: Mr. Michael Leon Cook, 1005 Crest Place, Kent, WA, 98031, US

(73) Assignee: Mr. Michael Cook, Kent, WA (US)

(21) Appl. No.: 11/998,722

(22) Filed: Dec. 3, 2007

(51) Int. Cl. G06F 17/00; B64C 21/10

(52) U.S. Cl. 701/3; 244/200

(57) ABSTRACT

A method is provided whereby airplanes or any device with the functionality and usefulness of an airplane may be controlled without the use of any traditional effectors, such as flaps, rudders, ailerons, spoilers, and all like hinged, moveable airfoils attached to a wing or a fuselage. The means of controlling such airplanes while in flight will be by controlling the laminar air flow over all lifting surfaces so as to vary the amount and quality of the lift provided. All lifting surfaces on the airplane will be divided into dozens, hundreds, or thousands of small zones, each of which can be readily controlled by a central flight computer and each of which is capable of modifying its immediate airflow condition, whether that be laminar flow or some particular degree and variety of local eddy current. Summing over all the inputs of conditions above the multitude of zones, the central flight computer will possess algorithms and programs suitable to effect any desired change in attitude, altitude, orientation, and course of the airplane that is desired.

### CROSS-REFERENCE TO RELATED APPLICATION

Related application Ser. No. 11/084,780 filed on Mar. 21, 2005. Provisional Application # 61/000,837 Filed Oct. 30, 2007

### FEDERALLY SPONSORED RESEARCH

### BACKGROUND OF THE INVENTION

1. Prior Art

This invention relates to a method of controlling the pitch, roll, and yaw of an airplane or any device with airplane-like functionality, without the use of either moveable effectors, space-vehicle style thrusters, or directed main engine thrust, by instead relying upon the precision management of volumes of air being sucked or blown through micro-holes, micro-slats, and micro-openings of any shape distributed in any pattern of sufficient density over an airfoil surface, which precision of flow management is so precise, timely, and efficacious that local flow conditions over an airfoil can be minutely adjusted so as to control any device with airplane-like functionality and usefulness, defeat icing, cool surfaces of the aircraft being aerodynamically heated, aid decontamination, counter turbulence effects on the aircraft, and even to help clean and maintain the micro-openings themselves.

2. Background—Prior Art

The maintenance of optimal laminar flow over an airfoil is a subject that has many inventors engaged in making proposals on how to prolong optimal laminar flow by means of a microporous airfoil or a microperforated airfoil underlain by a vacuum chamber. This approach at first seemed so promising that a great number of patents based on said approach were granted, notwithstanding the fact that there is little real-world data available on this emergent technology because of national security restrictions and the proprietary interests of the Boeing Corporation, headquarters Chicago.

Nevertheless, enough is understood at least theoretically that many inventors are plunging ahead. Perhaps the foremost of these inventors providing useful delineations of the nature of the technical problem, although they take quite different strategies in quest of solutions that will be flyable in the real world, are Bertolotti, U.S. Pat. No. 7,152,829, published December, 2006, whose assignee is Airbus Deutschland GmbH, and Federov. U.S. Pat. No. 5,884,871 Published, March, 1999, whose assignee is Boeing North American, Inc.

Before analyzing Bertolotti's and Federov's competing philosophies, it is useful to consider the crash of a twin-engine commuter airplane near Chicago in 1989 that killed 21 people. Investigation eventually revealed that a special form of super-cooled rain had caused icing on the top surface of the wing beyond the de-icing boot, which boot only covered the leading edge of the wing. If the ice, which had extended backwards on the wing about 600 cm beyond the boot, had remained smooth, everything would have remained fine for the passengers and crew that stormy night.

Unfortunately, the sheet ice on the front top of the wing had flaked off irregularly, producing a ridge. The ice forming the ridge wasn't more than one or two centimeters thick, but the irregular discontinuity thus created was so upsetting to the laminar flow that it created turbulent air which cascaded along the remaining wing chord length to the aileron, by which point the turbulence was so severe as to create a low pressure pocket that by sheer force pulled the aileron up by about 15 degrees!

This control input was sufficient to start the airplane to roll uncontrollably into a disastrous dive, but notice that the aileron itself did not cause the roll. The aileron was in such a turbulent region that it was merely reacting to events, not causing them or even able to counteract the situation which had been created. It was the almost imperceptible ice ridge acting as an aileron that actually took control of the airplane, mostly by destroying the lifting ability of the affected wing, which in turn caused the wing to roll downward towards the ground. The first important understanding we gain from this tragedy is that it doesn't take much meddling with the laminar flow stream of air over an airfoil to effect an awful lot of input into the orientation of a moving airplane. Any controllable deformation of a compressible airfoil surface may become a means of controlling an aircraft, or any method which mimics such a deformation by means of suction holes or blowing holes opening and closing in a controlled sequence. For this reason, developments in the field of biology become of interest, for the flexing of an artificial muscle can cause a basically smooth surface to bulge or indent and such flexing is initiated by a low voltage electrical signal.

Curiously, in none of Bertolotti's patents is attention paid to the remarkable fact that any method of manipulating the boundary layer over an airfoil will exert a force for aerodynamic control of an aircraft. What interests Bertolotti, and he says so several times, is how to maximize laminar flow during normal cruise condition so as to improve airplane fuel mileage. His feature addition to this art seems to be replacing circular microholes with mathematically calculated microslots.

All the other related competing patents cited by Bertolotti, spanning many decades, seem totally incurious or unaware of the possibility that, insofar as microperforated airfoils are able to regulate the laminar air flow, the said airfoils might therefore be capable of controlling an airplane in lieu of other traditional effectors such as ailerons, rudders, flaps, spoilers, tailfins, and such. This narrow view is echoed in an even narrower fashion by Federov, who perhaps having access to the Boeing experimental data of the mid-1990's does not seem much interested in the possibility of active and selective suction control to do anything desirable in a cost effective way. By 1999 Federov's focus is on a very passive type of absorbing wall, not a suction perforated foil, which wall at most will exhibit lots of tiny blind tunnels of a variety of sizes and orientations that in some of his embodiments are purposefully randomized. Federov's intention seems to be to identify certain streamlines in the laminar flow and then to customize the texture of the microporous airfoil surface in fixed ways that will delay the onset of transition to turbulent flow. This ability provides slight advantage at best in the broad envelope of potential flight conditions.

Federov generally draws the placement of these cylindrical blind microholes in a porous material as covering the regions where we would expect de-icing boots—on leading edges. The thinking at Boeing seems to dismiss the possibility of active vacuum management ever having any really practical use. If that pessimism is real, it is certainly disheartening coming from one of the world's premier aerospace research entities. This skepticism is understandable, however, when one looks at the maze of internal channels and vacuum chambers underlying the outer surface of airfoils that some inventors are coming up with, not to mention the reality of having to bleed off precious engine energy to create suction or blowing forces.

But all is not gloom on the active microperforation front. In particular, an inventor named Battisti, U.S. Pat. No. 6,488,238, December 2002, reveals an enthusiasm for the utility of using tiny suction or blowing holes to achieve boundary layer control. Mr. Battisti seems particularly keen on the idea that blade loading in turbo engines can be increased by devising complicated internal channels within engine compressor blades not only to increase blade loading significantly, but also to provide critical cooling. To do this Battisti will use not suction, but injection of fluid through micro-openings, that fluid most often being air. Mr. Battisti acknowledges that injection for maintaining boundary layer control isn't terribly efficient when talking about airfoils like wings, but for turbo engines he says it is just the thing. Battisti also contemplates using unspecified electro forming techniques for the manufacture of blades with suitable channels and microperforations. Although Battisti hopefully suggests automotive uses for his patent, probably thinking about supercharger turbines, he mentions using either suction or injection methods of boundary layer control in relation to thermal performance only regarding turbine engine blades, and never in regard to steering a vehicle or airplane-like structure or for cooling outward surfaces of an aircraft being aerodynamically heated,

Another inventor not thinking about how to steer or maneuver an aircraft through the sky is Hirschel et all, 1990, assignee Messerschmidt-Boelkow-Blohm GmbH. Mr. Ernst Hirschel provides instructive teachings on the art of etching the surface skin of airfoils with sharp edged or fine ridges and groves, whether the skin be made of metal or fiber composite material. Hirschel extensively cites publication AIAA-83-0227 published by the American Institute of Aeronautics and Astronautics titled “Turbulent Drag Reduction for External Flows” by Bushnell, which article shows various riblet configurations with sharp V-grove peak to peak spacings ranging from 0.25 mm to 3.15 mm and parallel ribs with curvy peaks and curved valleys ranging from 0.1 to 0.7 mm. Hirschel et al also reaches back to the Summer, 1980, Vol. 5, Nr. 2 NASA Tech Briefs for an article by M. J. Walsh which advocates ribbings having spacings of at least 0.254 mm. Hirschel teaches that Walsh's spacings (and maybe Bushnell's) are too large to be efficient. Hirschel also disputes Walsh's idea of machining such grooves in aircraft skin, Hirschel saying that machining tools (as of 1988 when Hirschel's patent was filed) are not up to the job.

Interestingly, Hirschel cites an old German Patent Publication (DE-OS) 1,923,633 which discussed attaching a fur or pelt type member to the surface of an aircraft skin. Hirschel teaches that the disadvantage of all schemes that intend to simply glue a foil or film that has ribbing on it onto the skin of an existing aircraft is that too much weight is invariably added to the aircraft and that the applied layers tend to erode quickly and are too easily damaged. All in all, riblets may work, but they are too expensive and too much trouble.

An important thing to note is that most aircraft control movements cut fuel mileage. Even trimming an airplane to fly straight can cut fuel efficiency in the short run. In general, inventors who acknowledge that boundary layer control may still represent a promising venue of aerospace research seem not to be thinking of boundary layer control as a means of controlling either aerospace vehicles or airplane-like structures. The focus seems to be on cutting the per-seat cost of travel in commercial airplanes.

The present invention will remedy this universal oversight by inventors, even those close to major airplane builders. Suppose we take all the art of Bertolotti, Federov, and some others as being of merit, as far as they go. The general preference seems to be for perforating some airfoil material suitable for precise drilling with maybe a million tiny holes or more per square meter. Boeing used titanium as the base airfoil skin on the top of F-16XL wings in government sponsored trials in the mid-1990's. Titanium is good for the purpose because not every material is strong enough to endure a million tiny holes being punched in it and still be strong enough to function as an airfoil.

Underneath the titanium top layer of the F-16XL airfoils the Boeing engineers apparently just created a sufficient vacuum for the whole area on top of two F-16XL wings and let it go at that, even though such large and connected vacuum chambers can have a wide variety of internal pressures because of internal physical structures in the wings restricting some flows, because of uneven atmospheric pressures over the outside chords and span of a wing, and because of consequent uneven local suction regions that will therefore be generated internally within the airfoil.

Some previous art seeks to rectify such unevenness by basically using microporosity or microperforations as a way to blow air from regions that have too much pressure, such as leading edges and trailing edges in the vicinity of effectors into regions where the pressure is too low, like in the middle of the wing, through channels and chambers. If it worked well, this would be a self-adjusting process not needing either analytic energy or outside control input, not to mention gating mechanisms in the ductwork so as to adjust suction levels locally by command. Federov downplays the usefulness of such schemes. If anything, these plans will lead to disrupting laminar flow, he says, and the complicated hardware is impractical.

The objection to the impracticality of complicated ductwork may be mitigated by continuous advances in the art of computer guided fabrication techniques. Two very important teachings in the art that will benefit the present invention can be found in the patent of Ghosh, 2003, at the University of Michigan, Ann Arbor, and partially funded by the U.S. Office of Naval Research. First, Ghosh talks about open cell metal foams and metalized fiber structures and cites a large number of patents regarding all that art. But Ghosh's invention involves fabricating objects in the micron range having a fiber, wire, or foil core. He claims the advantage of a rapid deposition process in which a pressurized fluid stream leaves precision deposits welded to the substrate. The objects formed from the deposit can be 95% porous themselves or completely solid. Ghosh further asserts that his process can rapidly form intricate interior shapes in micro-sized objects without the slow and expensive process of casting dies. There seems to be plentiful new art available on precision depositing techniques, whether they be based on plasma or photocopying methods, such as Schmidt, 2003. By means of such methods it will be less expensive to provide the microvalves of the present invention with a channeled supply of either overpressure fluid or of vacuum. Gradations of either would be quite useful, particularly a range of two or three levels of vacuum. Schmidt's teachings cover various methods of producing micro-openings, including vibrating embossing devices or embossing dies. Schmidt disparages laser drilling processes because they are sequential. A laser which is directed to drill a million tiny holes will do them one at a time. Parallel processes favored by Schmidt like plasma drilling or photo-structuring may produce a great number of holes simultaneously.

De Steur, et all, 2003, has some things to say in defense of laser drilling of micro-holes. His teachings are of particular interest in regards to the present invention because De Steur discusses at length techniques for drilling through alternating thin layers of metals and dielectric materials using a neodymium vanadate laser. The disadvantage of this being a sequential process can be overcome economically by the fact that multiple lasers can be assigned the task of drilling micro-holes in a structure as large as the wing of a 747 jumbo jet. Further, such lasers are generally controlled by robots which work tirelessly and with little human input once they are programmed. It may take months for several dozen robotic lasers to drill a hundred million or more holes in a huge wing, but the human time clocked on the job will be relatively small, just a handful of technicians and engineers to monitor the around-the-clock drilling operation periodically.

More art that will be of importance to the implementation of the invention can be found in the patent of Arimondi et al, 2007, whose teachings on the process for manufacturing micro-structured fiber filaments truly reflect state-of-the-art information. The plunging needle filament of the microvalve the present invention introduces into a microperforation that may be only 50 microns in diameter but as much as 10 centimeters in length will resemble a thin filament capable of conducting a laser beam or, a hollow inner channel being provided, a fluid non-viscous enough to overcome the friction of such a constrained channel, and such fluid able to benefit from capillary action.

Boeing is the assignee of a patent by Mangiarotty, 1986, that proposed using ultrasound to retard the point of transition from laminar flow to turbulent flow. The sound would be generated from devices like speakers in the wings at frequencies greater than twice the critical Tollmein-Schlichting frequency and the acoustic energy would be focused at the boundary layer. The present invention may be adaptable to benefiting from this effect, for the reason that it already has a reason to generate small amounts of ultrasound for cleaning purposes.

Returning to the subject of suction, Bertolloti, he of the Airbus connection, seems to understand that a one-vacuum-pressure-fits-all large chamber is not the best approach because there will be over-suction in some areas and inadequate suction in others. He devises rather complicated mechanical means by which zones, or as Bertolotti terms them, bundles, of micro-slats can experience different degrees of suction. Once again, most such inventors aren't aiming to do anything except fine-tune the suction system so that it will efficiently help the airplane achieve maximum fuel economy in a rock-steady cruise condition. If one started monkeying around with different zones of suction pressure, one might destabilize the cruise condition and end up turning the airplane or something!

In present practice of the art as of late 2007, the realm of micro-slots, slats, dams, passive channeling schemes, ribbing patterns, powered active suction mechanisms, and micro-perforations of whatever shape and depth, all seem relegated to placements around the leading and trailing edges of wings or other airfoils. Although these areas are critical during certain shorter portions of the flight envelope, they are almost irrelevant to anything other than the current holy grail of contemporary aeronautic design: to with, saving every last drop of fuel possible during the dull hours and hours that aircraft will spend in the cruise condition. Turning and steering the airplane by some exotic method related to all the foregoing micro-ideas will be a hard sell unless economies or some very special attendant advantages can be delivered as well.

### SUMMARY OF THE INVENTION

But turn the airplane is exactly what the present invention intends to do. In fact, it intends to control aerobatically any device that mimics the functionality and usefulness of an airplane. Better yet, the present inventor intends to effectively fill each micro-opening in a microperforated airfoil with a micro-robotic valve that, on command, will regulate vacuum suction or fluid injection so precisely that a wing which is covered with such an airfoil will be able to defeat surface or near-surface turbulence effects as they arise, no matter how small, particularly if sensing elements embedded in airfoils provide pressure and air speed information to a central computer capable of deciding in micro-seconds how to instruct each micro-opening to perform, or to instruct whole zones of micro-valves, which we will now term microvalves, how to operate in concert. Each said microvalve will also provide the central airplane flight controller with feedbacks from sensors integral to each local section of airfoil—a local surface sensor of local air pressure, a sensor in the mid-section of the said microvalve that senses flow rate through the valve and the presence of obstructions, and a local sensor opening on the interior vacuum chamber or plurality of chamber that senses local vacuum pressure.

Multiply these data outputs by maybe ten million microvalves in a plurality of contiguous microperforated panel and you give the central flight computer a lot of data to work with. You also give this computer, imaginatively programmed, considerable potential to do things with the boundary air moving over an airfoil that have yet to be dreamed of. By the way, we employ the term microporous in connection with schemes like that of Federov, where his little holes are blind and not connected to any vacuum generator. We use the term microperforated to refer to through-hole schemes like Bertolotti's, where vacuum is intentionally generated and shunted around, combined with a lot of thought going into the shape and lay-outs of whole fields of precisely machined micro-openings, which Bertollotti refers to as microslots.

In an alternative embodiment, said plurality of microvalve will possess a third mode by which they will close off all venting to outside air and by means of collective suction will actually compress a rubberized airfoil material in which they might be embedded by up to 3 cm. Each said microvalve is very tiny, but together they can be mighty. The advantage of this would (be) in environments where it is just too dusty or icy for normal operations. In effect, more of the airfoil would become a de-icing boot, but a boot that pays attention to the aerodynamic effects it may cause, such as turning the aircraft. It may seem unusual to build any airfoil or wing out of material as thick as 1-10 centimeters, but recent advances in the art of aerospace metallurgy have created a material called open cell aluminum foam. This material, or similar materials, when used in conjunction with microvalves to be manufactured by the same art as presently being used in the fields of biological research, electronic circuit board and chip fabrication, micro-plasma cutting technology, micro-electroplating technology, micro-pattern and form building through photocopying processes, and micro-fiber optic cable manufacture with attendant fiber optic valves, splitters, and splicers, all provide abundant new art sufficient to make the necessary microvalves and any other micro devices required by the present invention.

The use of thicker, layerized airfoil skin materials up to 10 cm thick will not accommodate all wing and other airfoil designs, of course, as it will steal volume from thin wings and limit the capacity of wing fuel tanks. On the other hand, doing away with mechanical/hydraulic means of controlling airfoil effectors saves on interior space.

The present invention and its plurality of microvalve may seem like it would be impossibly expensive, but the teachings of patents which concern the forming of micrometer perforations in electronic circuit boards made of layers of materials each possessing unique qualities, such that electrically conductive layers can supply power to each micro-valve, suggests the exact opposite. In fact, even technology developed in the field of microbiology, particularly art for the purpose of focusing ultrasound beams suggests cross-over uses, for focused ultra sound is being made to do very fine tasks on small scales, such as ablating new holes or cleaning old ones. Cleaning of micro-perforations is an important challenge when attempting to put microperforated airfoils into action in the air, especially so when said microperforated airfoils are intended to be the main means of controlling an airplane.

The expense of creating a big airfoil that will be mass-produced like a circuit board will be offset by the potential to simply not build expensive ailerons, flaps, spoilers, or other mechanical effectors for controlling flight. Wings or empennage elements in the present invention can be very simple, strong, and elegant structures. Doing away with hinged mechanical effectors prevents many sources of mechanical failure and will improve performance in extreme flight envelopes. The military utility of a wing that can be instantly reprogrammed to use almost any part of its surface to regain aerodynamic control after sustaining damage seems obvious. Many an aircraft has been lost because enemy projectiles damaged hydraulic lines or jammed an aileron into an unwanted position. The present invention represents a logical extension of fly-by-wire technology as a central flight computer communicating individually with tens of millions of micro-openings has a multitude of possibilities at hand in order to regain control of a damaged aircraft. A wing can even be largely blown off and the remaining stub of a wing can have its microvalves and vacuum generating source instructed to absolutely maximize wing loading to the remaining structure. Such maximization may be inefficient for normal operations, but survival is not a normal operation.

For the most part, however, the big enemy of boundary layer control through micro suction or injection methods is dirt and other contamination. The kinds of contaminants that can invade, clog, or cover over micro-openings, even while in-flight, are dry dust particles, fluid droplets, electrostatically sticky particles that may be either dry particles, droplets, or something in between; chemically sticky compounds, or biological growths. Potential methods of cleaning include precision directed high pressure gas or fluid ablation, precision directed laser emission, use of ozonation or of hydrogen peroxide-coated microbubbles to remove organic growths, focused ultrasound waves, microwave

RF radiation for thermal cleaning, wet washing and drying techniques, and mechanical re-perforation of holes in flight by a moveable, indented perforation plate pressed into position and then extracted and moved to a new zone robotically. In the instance of microvalves, the hole through the valve is not being re-perforated, merely unplugged by a piston-like probe. This probe may be a specialized tool only introduced at the scene in maintenance sessions when the aircraft is on the ground. In normal flight operations the functionality of the probe is provided in-flight by an element of the microvalve assembly itself, to be described in a few paragraphs to follow.

A possible objection to the present invention would be that a system which does away with all other methods of control except for microvalves embedded in airfoils supported by vacuum generation or engine bleed-off would be vulnerable to a power-out situation leaving an aircraft uncontrollable. A rhetorical answer to this objection is this—how controllable is an Airbus 380 if all power systems go out? A practical answer to the question, however, is to stipulate that this system is intended for space launch and possibly military purposes, not the hauling of passengers.

### BRIEF DESCRIPTION OF THE DRAWINGS

FIG. 1 An airplane-like bendable wing having 90% of its upper surface covered with microperforated zones of airfoil and indicating the presence of a central flight computer in the fuselage.

FIG. 2 Typical array of micro-hole openings on a micro-perforated airfoil showing slight compression left to right. The hole-to-hole distance may be from 5 microns to several centimeters (in specified areas of extremely low density)

FIG. 3 A cutaway section of the microperforated airfoil, which reveals a single micro-perforation through-hole into which has been inserted on the interior side of the airfoil a single microvalve stator sleeve. THIS DRAWING AND THE OTHERS OF THIS STRUCTURE HAVE BEEN DISTORTED IN WIDTH (in this view, from side to side of the page) FOR CONVENIENCE OF ILLUSTRATION. IN ACTUALITY THE THROUGH-HOLE AND THE STATOR SLEEVE WOULD BE ALMOST HAIR-LIKE IN THICKNESS HORIZONTALLY. Also shown is part of the microvalve plunging needle element in the blind hole position. The fat rotor end of the microvalve plunging needle element would be off the bottom of the page and is not shown.

FIG. 4 A depiction of the microvalve plunging needle filament, one crimp-on bushing, and the bulging rotor element of the microvalve. Not shown on the bottom is an optionally lower extended portion of the plunging needle filament attaching to a common frame (which may be tens of centimeters away and not shown here) with other needle filaments, for the purpose of increasing compression pressure.

FIG. 5 A cutaway section of a microvalve fully assembled with the plunging needle filament inserted into the microvalve sleeve. Rotor and stator are now in working position, but their means of electrical connection to the conductive layers of the airfoil are not shown, nor are the electrical connections by which these conductive layers are energized by command of the central flight computer. The siren vane crimp bushing on the plunging needle filament is exposed to the airstream in a mode that may be for the sonic cleaning process, or may be for providing a local aerodynamic effect at the command of the computer. Should such a small electric motor be impossible to construct, a pneumatic method of spinning the siren vane bushing would be the alternative embodiment. In the latter embodiment the siren vane bushing would not be crimped on the plunging needle filament, but would spin freely. The vanes should be cut to produce a wail of from 100 to 10,000 Hz, depending on whether more cleaning or more delay of transition is sought.

FIG. 6 A cutaway depiction of the plunging needle filament in the flush-with-surface mode where the siren vane crimp bushing is able to descend no further because of command positioning communicated via the microvalve sleeve bushing. When under tension from below the plunging needle filament will exert pressure on this contact surface. The plunging needle filament may assume any position between the extremes shown in FIGS. 3 and 5, including a mode where it is flush with the surface of the airfoil.

FIG. 7 Shows the boundary layer air flow being drawn down and modified by suction applied to the surface of the microporous airfoil skin through the microvalves. Depression of the surface of a specified zone of the airfoil skin will cause the same effect. Blowing through the microvalves or overpressure supplied to any permeable inner compressible layer may cause the opposite effect.

FIG. 8 THIS DRAWING AND FIGS. 3, 4, 5, and 6 OF THIS STRUCTURE HAVE BEEN DISTORTED IN WIDTH (in this view, from side to side of the page) FOR CONVENIENCE OF ILLUSTRATION. IN ACTUALITY THE THROUGH-HOLE AND THE STATOR SLEEVE WOULD BE ALMOST HAIR-LIKE IN THICKNESS HORIZONTALLY. Also shown is part of the microvalve plunging needle element in the ultra-sound generating or singing position. The nearby pressure sensing element is not numbered in this drawing, but by its feedback allows precise tuning of the ultrasound generated in the bulbous plenum by minutely adjusting the positioning of the microvalve plunging needle element.

### DRAWINGS—REFERENCE NUMERALS

1 bendable, micro-perforated outer skin of the airfoil, microvalves much too small to be seen in this view.

2 open cell metal foam layer with electrical conductivity

3 compressible rubberized dielectric layer with integral horizontal through channels (not shown) for the passage of fluid from points of introduction (not shown)

4 open cell metal foam layer with electrical conductivity

5 compressible rubberized dielectric layer

6 open cell metal foam layer with electrical conductivity

7 compressible rubberized dielectric layer

8 open cell metal foam layer with electrical conductivity

9 microvalve sleeve extending up to flush with the outermost skin and possessing a stator (not shown) in a wide portion further down the shaft

10 flight control computer

11 microvalve flow volume sensor and pressure sensor

### DETAILED DESCRIPTION OF THE PREFERRED EMBODIMENT

The plurality of microvalve necessary to this invention will be based on variations of one simple design. At the core of the valve will be a plunging needle filament element shaped rather like an inverted golf tee of from one micron to ten centimeters in length. In closed position the tip of the tee will normally extend up to the plane of the exterior airfoil surface in which suitable perforations have been provided. It may extend past this plane for special purposes, like de-icing, cleaning, or to deliberately cause a particular type of eddy current in a specific local region.

The diameter of the surface micro-opening through which the microvalve will reach or protrude slightly will be from one micron to 250 microns. The diameter of the microvalve head at its wide point on the inside surface of the skin will be from 100 microns to 5 mm.

When the plunging needle filament element retracts into the microperforation, powered by either or both a tension force applied to the plunging needle filament or the vacuum which occupies the airfoil's internal vacuum chamber, the eddy current due to the plunging needle filament element's slight protrusion into the airstream will be replaced by the suction effect as air or other fluid enters the core of the microperforation drawn by vacuum subject to the venturi effect. In normal cruise operation, the plunging needle filament element may stop in its retraction so as to form a through hole to a vacuum chamber, or it may withdraw, forming a blind hole, or it may form shallower blind holes,

The trigger for the opening of the microvalve will be a command electric impulse through electrically conductive elements embedded in the multiple layers of which the airfoil is constructed. Some layers are there simply to provide an electric potential for either direct current or A/C. Open cell foam made of aluminum alloys conducts electricity well and supplies strength to undergird a thin top layer of the airfoil made of a hard metal like titanium or stainless steel. At least one rubberized layer will include dielectric fiber material in such an arrangement as to freely allow lateral fluid flow through the material and from there into the shaft of the micro-hole. When compressed, a bellows effect will provide overpressure, when decompressed, a reverse bellows effect provides suction.

Other layers are made of carbon composite materials woven in a cross-hatch pattern in order to insulate between the electrically conducting layers. Since this method calls for basically the construction of large metal plates interposed with dielectric material, it should be noted that these plates not only provide an electrical method of energizing and controlling millions of microvalves, but there will inevitably be a capacitance effect in the airfoil, which can be used for energy storage. A side benefit of all the metal in this embodiment is that it protects airplanes which are flying through lightning storms by routing atmospheric discharges around the vehicle rather than perhaps burning a hole through it. A very important side-effect of the capacitance potential between conducting layers in any specified zone is the fact that considerable electromagnetic attraction or repulsion can be exerted between layers. Any compressible layer between charged layers can be compressed significantly, thus affecting the configuration of the outside skin of the airfoil by up to several centimeters. It is fair to say that the sucking and blowing of fluid through the microvalves mimics aerodynamically the effect of electromagnetically depressing or inflating the outside skin. Although each effect may only contribute the equivalent of a few centimeters in movement, they can supplement each other or cancel each other on command.

Notice the variety of effects the piston-like plunging needle filament of the microvalve can cause, and the variety of ways said computer can move said needle filament. Said computer could single out just one microvalve which is signaling it is plugged and direct the plunging needle filament of that microvalve upward to the maximum, even to poking out a little in the airstream where, by energizing the electric motor elements (rotor and stator) of the microvalve, the needle valve may be spun at various rates, which will cause the siren vane crimp bushing to produce continuously variable eddy currents. Or, if suction is available from vacuum in the underlying main chamber, the plunging needle filament can be withdrawn to the to blind hole depth to clear debris from the throat of the valve by overpressure which may be squeezed out of a compressible layer. Notice that the siren vanes on the crimp bushing will make serviceable grinding teeth for debris.

In certain periods of flight there may not be vacuum in the underlying chamber, but over-pressure, which can be used in conjunction with electromagnetic energy and suction or overpressure layers in the airfoil to hold all the microvalves tightly in a firm position, either leaving blind holes of a desired depth, no holes and a flush surface, or a five o'clock shadow type of surface bristly with slightly protruding plunging needle filaments. If nanotechnology advances sufficiently, it may be possible to provide said plunging needle filaments with a controllable inner through pipe of their own, so that the overpressure from said main chamber will still hold the main part of the microvalve in place, but air or other fluid will be able to pass through the plunging needle filament channel to exert a blowing force on the boundary layer or to dislodge debris if the body of the needle valve becomes stuck. A preferred method of providing overpressure is to have at least one distinct layer of the airfoil capable of laterally passing a fluid through itself. This layer may be a vacuum chamber or it may be an overpressure chamber. It will not be strictly isolated in a plumbing sense from the large interior wing vacuum chamber, but it will be capable of overpowering the effects of that chamber temporarily and locally with a blast of overpressure to clean all the microholes in a designated zone.

Said computer will see an airfoil as both a field of millions of microvalves and as one or more zones in a grid of any geometric shape by which said grid a single microvalve, or a small zone of microvalves, may be commanded by said computer control to assume an open position, a closed position, or any setting in between. The valve setting is enacted by the plunging needle filament moving within the microperforation under its ability to act as an electric solenoid with travel up to five millimeters, or the ability of said plunging needle filament to rotate from 0 to some multiple of 360 degrees in its function as the rotor of a simple electric motor.

The wet cleaning methods used in electronic circuit board construction and biological research industries might also be used in wings or other airfoils with available fluid pressure, to wash out clogged holes and eject debris into the air stream. The fluid for this purpose to be carried on an aircraft might have chemistry suitable for de-icing as well. Another means to clean micro-holes is with laser light and RF radiation, which also can remove ice and might be directed through the shaft of the needle valve itself should that shaft be constructed of fiber-optic or RF conductive cable. A simple way to clean microperforations, if possible, is to accelerate the aircraft or a portion of the airframe to speeds where aerodynamic heating becomes intense. This causes holes in a metal foil to expand so as to loosen obstructions and also causes many contaminants to burn away. This is another thermal method of cleaning, considering microwave and some laser methods to also be thermal methods. In all cases, a sequence of cleaning steps should have microvalves that are somewhere downstream from those microperforations being cleansed upstream to be tightly closed, so that recently expunged debris moving in the fluid stream will not be immediately sucked into downstream microvalves in a condition of normal operation.

Returning to Schmidt, the plasma-drilling authority on the state of that art, as plasma-drilled holes get deeper, they tend to undercut, which is OK in this application as the present invention benefits from some undercut so as to allow liquid flow around certain slender portions of the plunging needle filament or to fit the fat inverted golf tee interior end of the microvalve. The cleaning also makes sure that the conductive layers are fully presented for sliding contact with the plunging needle filament and microvalve casing.

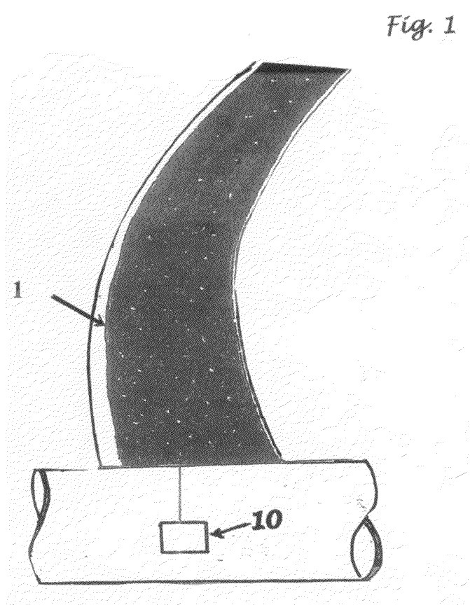

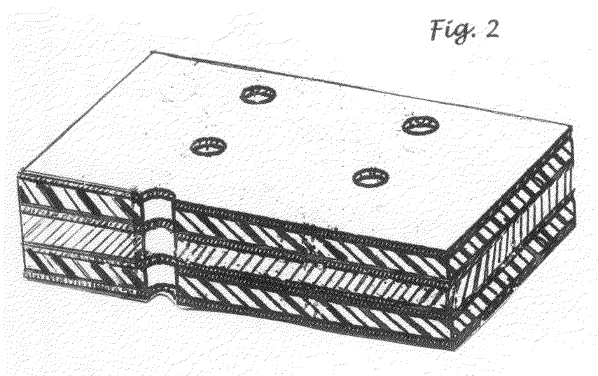

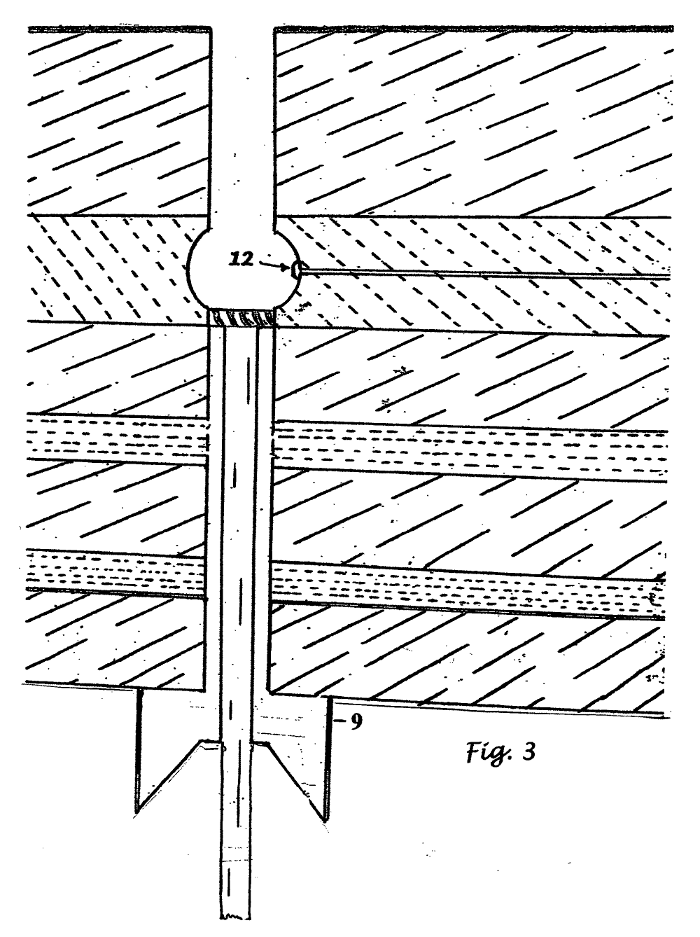

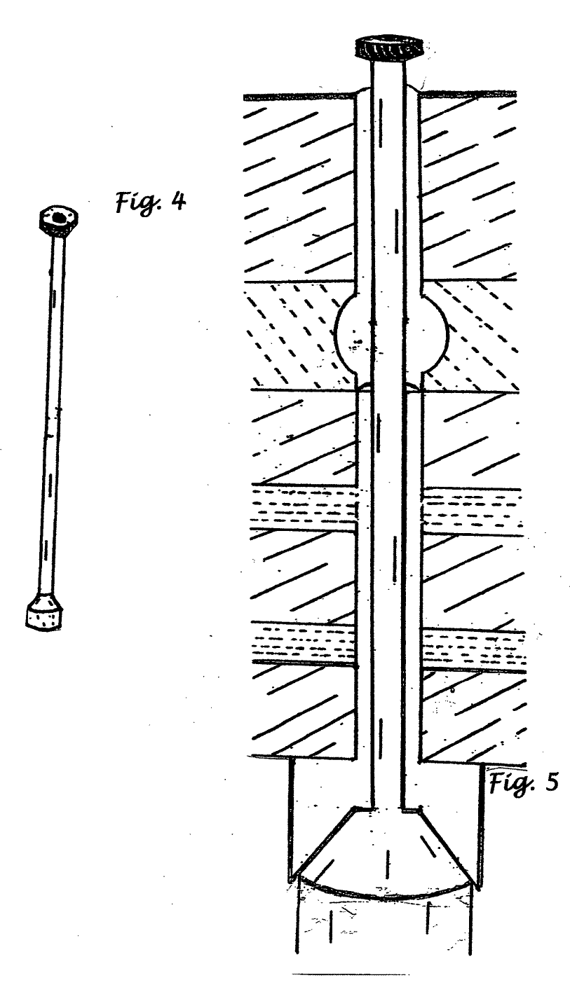

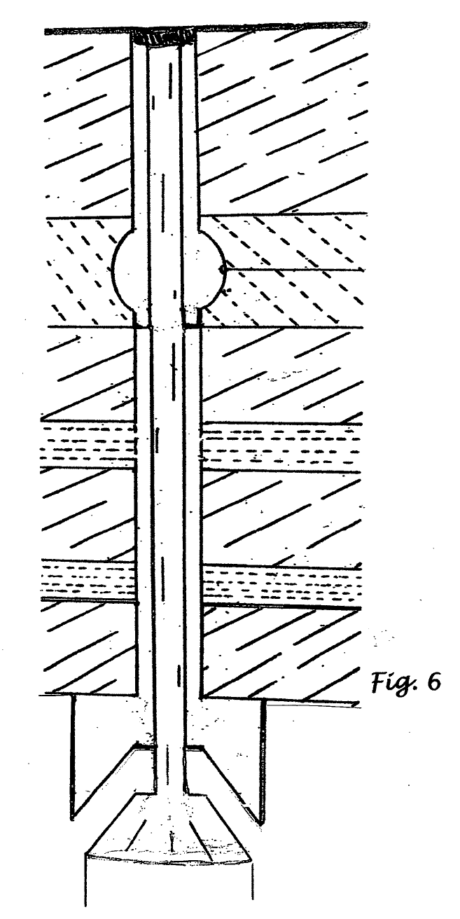

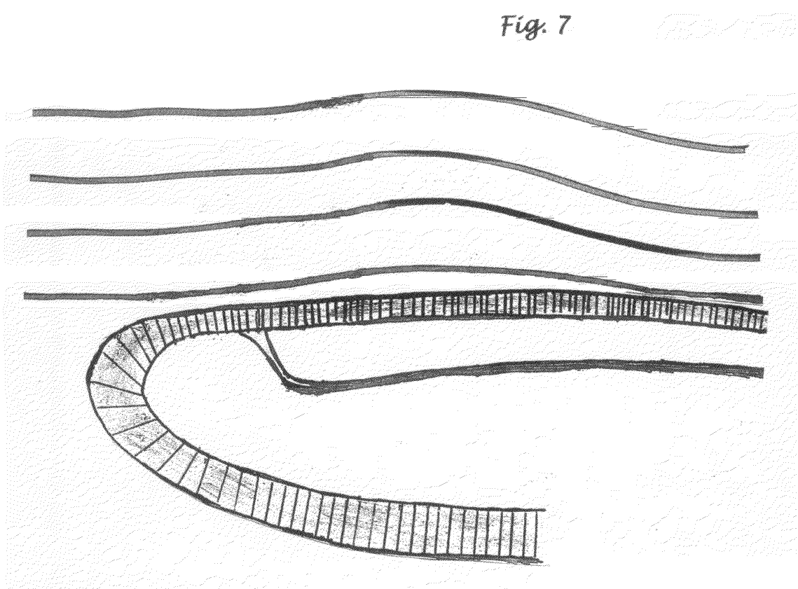

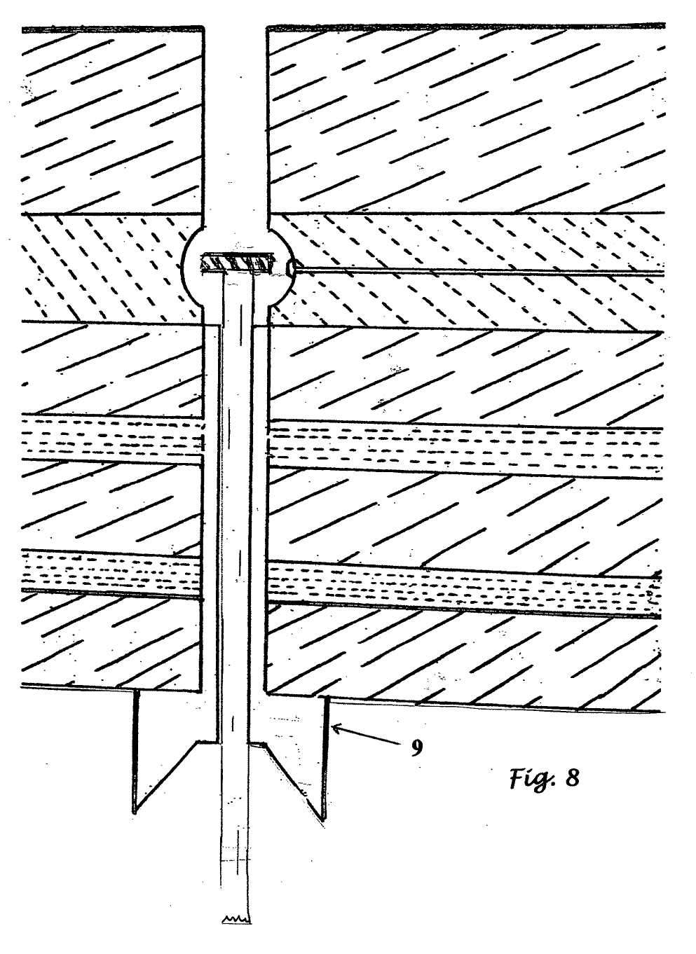

As employed in this invention the term “computer” refers to devices known to persons skilled in the art capable of processing hundreds of millions of data bits near-simultaneously and of enacting algorithms that model aerodynamic events in order to predict necessary control measures. The present invention neither suggests or requires any advancement in the art of computers in able to function, nor is a computer or its attendant connections illustrated herein except, very simply, in FIG. 1.

When the terms micro or micron are used in this application they refers to measurements most conveniently made in graduations of one-thousandth of a millimeter.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed and desired to be secured by Letters Patent of the United States is:

1) Method for controlling the roll, pitch, and yaw of an airplane or any device having the functionality and usefulness of an airplane, which semi-finished components consist of a microperforated airfoil itself consisting of a plurality of layers of compressible dielectric material and a plurality of layers of electrically conductive materials, said airfoil being perforated with a plurality of through-holes of from 1 micron to 250 microns in diameter and from 1 mm to 5 to 10 cm in depth, and a plurality of microvalve inserted in the plurality of microperforation through-holes of said airfoil, comprising the steps of:
a) charging said plurality of layers of electrically conducting materials in certain specified zones with opposing polarity, so that said layers store energy as capacitors and attract each other electro-magnetically;
b) compressing any interceding dielectric layers; thereby
c) depressing certain zones of the outside skin of the microperforated airfoil by several centimeters, thereby
d) exerting a sufficient control effect.

2) Method in accordance with claim 1, wherein the microvalves introduce suction between said outside skin of the microperforated airfoil in certain specified zones and the boundary layer of airflow, thereby mimicking aerodynamically the depression of the microperforated airfoil by several centimeters and supplementing the depression produced by the steps of claim 1, exerting a sufficient control effect.

3) Method in accordance with claim 1, wherein said flight computer commands said layers of electrically conducting materials in certain specified zones to charge with identical polarity, causing the decompression of interceding dielectric layers and restoring certain specified depressed zone of said outside skin of the microperforated airfoil to its original configuration, exerting an admirably sufficient control effect.

4) Method in accordance with claim 1, wherein said flight computer commands said plurality of microvalve to introduce overpressure between said outside skin of the microperforated airfoil in certain specified zones and the boundary layer of airflow, thereby mimicking aerodynamically the restoration of said outside skin of the microperforated airfoil to its original configuration and ending the supplemental depression produced by the steps of claim 2, exerting a sufficient control effect.

5) Method in accordance with claim 1, claim 2, and claim 4, wherein said plurality of microvalve varies the direction and intensity of fluid flow, thereby cleaning itself and the through-hole and serving to de-ice or decontaminate the airplane or device having the functionality and usefulness of an airplane and to cool a plurality of surface of said airplane which may be aerodynamically heated.

6) Method in accordance with claim 1 and claim 5, wherein the microvalve itself undertakes the step of producing sonic vibrations to supplement cleaning operations and help in delaying transition to non-laminar flow.
